(19) United States
(12) Patent Application Publication
(10) Pub. No.: US 2024/0143000 A1
(43) Pub. Date: May 2, 2024

(54) REMOTE DRIVING

(71) Applicant: BEIJING BAIDU NETCOM SCIENCE TECHNOLOGY CO., LTD., Beijing (CN)

(72) Inventors: Yu TIAN, Beijing (CN); Qingrui SUN, Beijing (CN); Jingchao FENG, Beijing (CN); Pengjie ZHENG, Beijing (CN); Dengyu XIAO, Beijing (CN); Xiaoteng YUAN, Beijing (CN); Liming XIA, Beijing (CN)

(21) Appl. No.: 18/409,710

(22) Filed: Jan. 10, 2024

(30) Foreign Application Priority Data
Mar. 30, 2023 (CN) 202310332420.9

(51) Int. Cl. G05D 1/80; G05D 1/227; G05D 109/10; G05D 111/10

(52) U.S. Cl. CPC G05D 1/80; G05D 1/227; G05D 2109/10; G05D 2111/10

(57) ABSTRACT

A method is provided that includes: obtaining a first state information of the remote driving system, where the remote driving system is configured to perform remote control on a vehicle communicatively connected with the remote driving system; determining whether an abnormality occurs in the remote driving system based on the first state information; determining abnormality information of the remote driving system in response to the occurrence of the abnormality in the remote driving system; and adjusting a state of the remote control based on the abnormality information.

### CROSS-REFERENCE TO RELATED APPLICATIONS

This application claims priority to Chinese patent application No. 202310332420.9, filed on Mar. 30, 2023, the contents of which are hereby incorporated by reference in their entirety for all purposes.

### TECHNICAL FIELD

The present disclosure relates to the field of computer technology, and in particular to the field of autonomous driving and remote driving technology, and specifically to a remote driving method, an electronic device, and a computer-readable storage medium.

### BACKGROUND

With the rapid development of autonomous driving technology and Internet of Things (IoT) technology, remote driving technology is gradually becoming the focus of attention. The remote driving technology can remotely operate an autonomous vehicle that is tens or even hundreds of kilometers away through a remote driving system, so that the remote driver can learn the environment and state of the autonomous vehicle in real time, and remotely assist the autonomous vehicle to complete the driving tasks safely.

The methods described in this section are not necessarily methods that have been previously conceived or employed. Unless otherwise indicated, it should not be assumed that any method described in this section is considered to be the prior art only due to its inclusion in this section Similarly, the problems mentioned in this section should not be assumed to be recognized in any prior art unless otherwise indicated.

### SUMMARY

According to an aspect of the present disclosure, a method is provided. The method includes: obtaining a first state information of a remote driving system, wherein the remote driving system is configured to perform remote control on a vehicle communicatively connected with the remote driving system; determining whether an abnormality occurs in the remote driving system based on the first state information; determining abnormality information of the remote driving system in response to the occurrence of the abnormality in the remote driving system; and adjusting a state of the remote control based on the abnormality information.

According to an aspect of the present disclosure, an electronic device is provided. The electronic device includes: a processor; and a memory communicatively connected to the processor, wherein the memory stores instructions executable by the processor, wherein the instructions, when executed by the processor, are configured to cause the processor to perform operations including: obtaining a first state information of a remote driving system, wherein the remote driving system is configured to perform remote control on a vehicle communicatively connected with the remote driving system; determining whether an abnormality occurs in the remote driving system based on the first state information; determining abnormality information of the remote driving system in response to the occurrence of the abnormality in the remote driving system; and adjusting a state of the remote control based on the abnormality information.

According to an aspect of the present disclosure, a non-transitory computer-readable storage medium is provided. The non-transitory computer-readable storage medium stores computer instructions, wherein the computer instructions are configured to enable a computer to perform operations including: obtaining a first state information of a remote driving system, wherein the remote driving system is configured to perform remote control on a vehicle communicatively connected with the remote driving system; determining whether an abnormality occurs in the remote driving system based on the first state information; determining abnormality information of the remote driving system in response to the occurrence of the abnormality in the remote driving system; and adjusting a state of the remote control based on the abnormality information.

### BRIEF DESCRIPTION OF THE DRAWINGS

The drawings illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein may be implemented according to embodiments of the present disclosure.

FIG. 2 illustrates a flowchart of a remote driving method according to an embodiment of the present disclosure.

FIG. 3 illustrates a schematic diagram of a remote driving system according to some embodiments of the present disclosure.

FIG. 4A illustrates a schematic diagram of abnormality information display of a remote driving system according to some embodiments of the present disclosure.

FIG. 4B illustrates a schematic diagram of early warning information of a remote driving system according to some embodiments of the present disclosure.

FIG. 5 illustrates a structural block diagram of a remote driving apparatus according to an embodiment of the present disclosure.

FIG. 6 illustrates a structural block diagram of an example electronic device that can be used to implement embodiments of the present disclosure.

### DETAILED DESCRIPTION OF EMBODIMENTS

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first”, “second” and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

The obtaining, storage and application of the user's personal information involved in the technical solutions of the present disclosure are in compliance with relevant laws and regulations and do not violate public order and morals.

A remote driving system can connect with an autonomous vehicle that is tens or even hundreds of kilometers away via a network, and remotely control the driving behavior of the connected vehicle. For example, the vehicle can be remotely controlled by the remote driving system to assist in the operation of the vehicle when the autonomous vehicle cannot operate autonomously. With the development of remote driving technology, the safety of remote driving is challenged in many ways. If an abnormality occurs in the remote driving system, the safety of remote driving will be affected. Therefore, the remote driving system needs to take a series of measures to ensure the safety thereof, so as to reduce the risk of remote driving.

With regard to the problems described above, embodiments of the present disclosure provide a remote driving method that can instantly detect and deal with an abnormal condition occured in a remote driving system, and improve the safety of the remote driving system to ensure the safety of remote driving.

Embodiments of the present disclosure will be described in detail below with reference to the accompanying drawings.

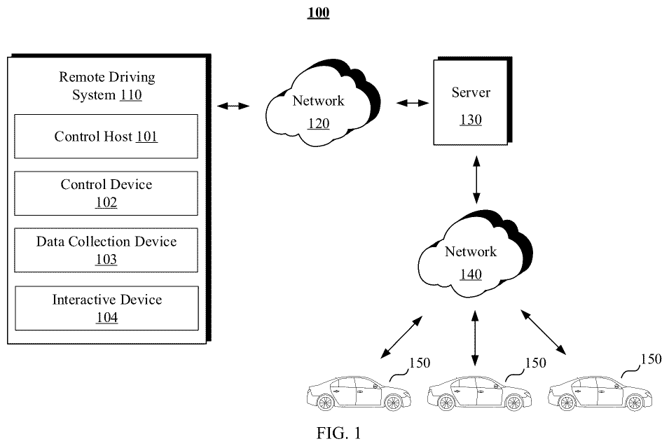

FIG. 1 illustrates a schematic diagram of an example system 100 in which various methods and apparatuses described herein may be implemented in accordance with embodiments of the present disclosure. Referring to FIG. 1, the system 100 includes a remote driving system 110, a server 130, and one or more communication networks 120 that couple the remote driving system to the server 130. The system 100 further includes one or more autonomous vehicles 150 and one or more communication networks 140 that couple the autonomous vehicles to the server 130. The one or more autonomous vehicles 150 may communicate with the remote driving system 110 via the server 130. The remote driving system 110 may implement a remote operation on the autonomous vehicle 150 through a control device 102, so as to remotely assist the autonomous vehicle in implementing safe driving. Although FIG. 1 depicts only three autonomous vehicles, those skilled in the art will be able to appreciate that the present disclosure may connect any number of autonomous vehicles.

The remote driving system 110 may be configured to execute one or more applications.

In embodiments of the present disclosure, the remote driving system 110 and the server 130 may run one or more services or software applications that enable execution of the remote driving method.

In some embodiments, server 130 may further provide other services or software applications, which may include non-virtual environments and virtual environments. In some embodiments, these services may be provided as web-based services or cloud services, such as to the remote driving system 110 under a Software as a Service (SaaS) model.

In the configuration shown in FIG. 1, the server 130 may include one or more components that implement functions performed by the server 130. These components may include software components, hardware components, or a combination thereof that are executable by one or more processors. A user operating the remote driving system 110 may sequentially utilize one or more client applications to interact with the server 130 to utilize the services provided by these components. It should be understood that a variety of different system configurations are possible, which may be different from the system 100. Therefore, FIG. 1 is an example of a system for implementing the various methods described herein and is not intended to be limiting.

The remote driving system 110 may provide an interface that enables the user of the remote driving system (the operator of the remote driving system 110, that is, the remote driver) to interact with the remote driving system. The remote driving system may also output information to the user via the interface.

The remote driving system 110 includes a control host 101, a control device 102, a data collection device 103, and an interactive device 104. According to some embodiments, the control device 102, the data collection device 103, and the interactive device 104 connect with the control host 101, respectively, for example, connect to a port (e.g., a USB port, an HDMI port, etc.) of the control host 101.

The control host 101 may include various types of computer devices, such as portable handheld devices, general-purpose computers, such as personal computers and laptop computers, workstation computers, wearable devices, smart screen devices, self-service terminal devices, service robots, in-vehicle devices, gaming systems, thin clients, various messaging devices, sensors, or other sensing devices, and the like. These computer devices may run various types and versions of software applications and operating systems, such as Microsoft Windows, Apple iOS, Unix-like operating systems, Linux or Linux-like operating systems; or include various mobile operating systems, such as Microsoft Windows Mobile OS, iOS, Windows Phone, Android. The portable handheld devices may include cellular telephones, smart phones, tablet computers, personal digital assistants (PDAs), and the like. The wearable devices may include head-mounted displays, such as smart glasses, and other devices. The gaming systems may include various handheld gaming devices, Internet-enabled gaming devices, and the like. The remote driving system can execute various different applications, such as various applications related to the Internet, communication applications (e.g., e-mail applications), Short Message Service (SMS) applications, and may use various communication protocols. The control host 101 may, for example, be implemented as an electronic device 600 as described below.

The control device 102 includes, for example, a brake, an accelerator, and a steering wheel. The brake, the accelerator, and the steering wheel may all be used to control the vehicle connected with the remote driving system.

The data collection device 103 includes, for example, an image collection device, an infrared camera, a temperature sensor, a humidity sensor, and the like. The image collection device includes a vision camera, which can capture the situation within the remote driving system in real time, for example, to obtain position coordinates of a screen and a steering wheel within the remote driving system. Sensors are used to perceive the environment within the remote driving system and/or around the remote driving system.

The interactive device 104 may provide interaction between the user and the remote driving system and implement the systems and techniques described herein on a computer, and the computer has: a display device (e.g., a CRT (cathode ray tube) or an LCD (liquid crystal display) monitor) for displaying information to a user; and a keyboard and pointing device (e.g., a mouse or trackball) by which a user may provide input to the remote driving system. Other types of devices may also be used to provide interaction with the user; for example, the feedback provided to the user may be any form of perception feedback (e.g., visual feedback, auditory feedback, or tactile feedback); and the input from the user may be received in any form, including acoustic input, voice input, or haptic input.

The network 120 and/or 140 may be any type of network well known to those skilled in the art, which may support data communication using any of a variety of available protocols (including but not limited to TCP/IP, SNA, IPX, etc.). By way of example only, one or more networks 120 and/or 140 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WiFi), and/or any combination of these and/or other networks.

The server 130 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 130 may include one or more virtual machines running a virtual operating system, or other computing architectures involving virtualization (e.g., one or more flexible pools of a logical storage device that may be virtualized to maintain virtual storage devices of a server). In various embodiments, the server 130 may run one or more services or software applications that provide the functions described below.

The computing unit in the server 130 may run one or more operating systems including any of the operating systems described above and any commercially available server operating system. The server 130 may also run any of a variety of additional server applications and/or intermediate layer applications, including a HTTP server, an FTP server, a CGI server, a Java server, a database server, etc.

In some implementations, the server 130 may include one or more applications to analyze and merge data feeds and/or event updates received from the remote driving system 110 and the autonomous vehicle 150. The server 130 may also include one or more applications to display the data feeds and/or the real-time events via one or more display devices of the remote driving system 110.

In some embodiments, the server 130 may be a server of a distributed system, or a server incorporating a blockchain. The server 130 may also be a cloud server, or an intelligent cloud computing server or an intelligent cloud host with an artificial intelligence technology. The cloud server is a host product in a cloud computing service system to overcome the defects of management difficulty and weak service expansibility exiting in a traditional physical host and virtual private server (VPS) service.

The system 100 of FIG. 1 may be configured and operated in various ways to enable application of various methods and apparatuses described according to the present disclosure.

According to some embodiments, the remote driving system 110 is configured to perform remote control on the vehicle 150. The remote driving system 110 (specifically, the control host 101 of the remote driving system 110) may perform an abnormality detection on itself according to a remote driving method in an embodiment of the present disclosure, and adjust a state of the remote control for the autonomous vehicle 150 according to the abnormality detection result. In the remote control, the remote driving system 110 may send a control instruction for the autonomous vehicle 150 to the server 130 via the network 120. The server 130 further sends the control instruction to one or more autonomous vehicles 150 via the network 140, thereby implementing remote control on the autonomous vehicle 150. Alternatively, the server 130 may also perform the abnormality detection on the remote driving system based on a remote driving method according to an embodiment of the present disclosure, and adjust the state of the remote control for the autonomous vehicle 150 based on the abnormality detection result.

Specifically, the remote driving system 110 or the server 130 may perform the remote driving method according to an embodiment of the present disclosure.

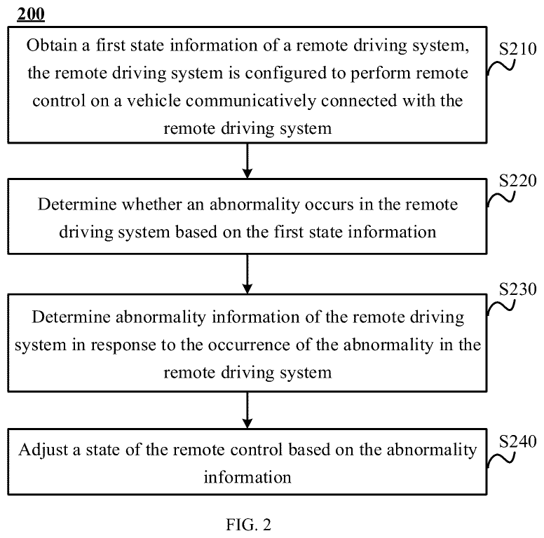

According to an embodiment of the present disclosure, there is provided a remote driving method. FIG. 2 shows a flowchart of a remote driving method 200 according to an embodiment of the present disclosure. The performing subject of each step of the method 200 is generally a remote driving system (e.g., the remote driving system 110 shown in FIG. 1 or other remote driving systems not shown in FIG. 1), or may be a server (e.g., the server 130 shown in FIG. 1 or other servers not shown in FIG. 1).

As shown in FIG. 2, the method 200 comprises steps S210-S240.

In step S210, obtaining a first state information of a remote driving system. The remote driving system is configured to perform remote control on a vehicle communicatively connected with the remote driving system.

In step S220, determining whether an abnormality occurs in the remote driving system based on the first state information.

In step S230, determining abnormality information of the remote driving system in response to the occurrence of the abnormality in the remote driving system.

In step 240, adjusting a state of the remote control based on the abnormality information.

According to an embodiment of the present disclosure, whether an abnormality occurs in a remote driving system is determined based on the state information of the remote driving system, so as to determine whether the remote driving system satisfies conditions for controlling a vehicle remotely. If an abnormality occurs in the remote driving system, the state of the remote control for the vehicle is adjusted based on the abnormality information, so that the control behavior of the remote driving system for the vehicle matches its current control capability, thereby ensuring the safety of remote driving.

Each step of the method 200 is described in detail below.

In step S210, obtaining a first state information of a remote driving system.

According to some embodiments, the remote driving system includes a control host and a hardware device. The control host may connect with the hardware device and control the hardware device based on a corresponding control instruction. The hardware device includes a control device, a data collection device, an interactive device, and the like. The first state information of the remote driving system includes state information of the control host of the remote driving system, state information of the control device, state information of the data collection device, state information of the interactive device, and the like.

According to some embodiments, the remote driving system may communicatively connect with a vehicle (e.g., the autonomous vehicle 150 shown in FIG. 1 or other vehicles not shown in FIG. 1) and perform remote control on the driving behavior of the vehicle.

In step S220, determining whether an abnormality occurs in the remote driving system based on the first state information.

According to some embodiments, the method 200 further includes obtaining a second state information of the vehicle communicatively connected with the remote driving system. Accordingly, whether the state of the remote driving system and the state of the vehicle are synchronized can be determined based on the first state information and the second state information; and in response to the state of the remote driving system and the state of the vehicle being out of synchronization, it is determined that an abnormality occurs in the remote driving system. Whether the state of the remote driving system and the state of the vehicle are synchronized is determined by using the first state information of the remote driving system and the second state information of the vehicle. If the state of the vehicle and the state of the remote driving system are not synchronized, it indicates that the remote driving system cannot accurately perceive the state of the vehicle, or the control instructions issued by the remote driving system cannot be well executed by the vehicle, therefore the remote driving system may have an abnormality. By using the method described above, whether the remote driving system is abnormal can be quickly determined, the safety of the remote driving system is improved to ensure the safety of remote driving.

According to some embodiments, the remote driving system includes a first control device, the vehicle includes a second control device, the first control device controls the second control device to cause the vehicle to generate a corresponding driving behavior, the first state information includes first motion information of the first control device, the second state information includes second motion information of the second control device, and determining whether the state of the remote driving system and the state of the vehicle are synchronized based on the first state information and the second state information comprises: determining that the second control device is not synchronized with the first control device in response to a difference between the second motion information and the first motion information being greater than a first threshold. If the difference between the motion information (e.g., a steering wheel rotation angle, an accelerator acceleration, etc.) of the control devices of the vehicle and the remote driving system is greater than the threshold, it indicates that the control devices of the vehicle and the remote driving system are in an asynchronous state. By using the method described above, whether the state of the remote driving system and the vehicle are synchronized can be quickly determined, the efficiency of abnormal state determination is improved, and the safety of remote driving is guaranteed.

According to some embodiments, the first control device may be a brake, an accelerator, a steering wheel, or the like of the remote driving system. The second control device may be a brake, an accelerator, a steering wheel, or the like of the vehicle. The first control device of the remote driving system can control the second control device of the vehicle to cause the controlled vehicle generate a driving behavior corresponding to the first control device. In the case that the first control device is the accelerator of the remote driving system, the second control device is the accelerator of the corresponding vehicle, the first motion information may be the acceleration instruction value of the remote driving system, and the second motion information may be the acceleration instruction value of the vehicle. If the difference between the acceleration instruction value of the vehicle and the acceleration instruction value of the remote driving system is greater than a threshold, it is indicated that the state of the remote driving system is not synchronized with the state of the vehicle. In the case that the first control device is the steering wheel of the remote driving system, the second control device is the steering wheel of the corresponding vehicle, the first motion information may be the steering wheel angle information of the remote driving system, and the second motion information may be the steering wheel angle information of the vehicle. If the difference between the steering wheel angle information of the vehicle and the steering wheel angle information of the remote driving system is greater than a threshold, it is indicated that the state of the remote driving system is not synchronized with the state of the vehicle. The control devices of the remote driving system may use the method described above to detect the synchronization state of the remote driving system and the vehicle, which is not repeated herein.

According to some embodiments, the remote driving system comprises a third control device and a fourth control device, the third control device controls the vehicle to generate a first driving behavior through a first control instruction, the fourth control device controls the vehicle to generate a second driving behavior through a second control instruction, the first driving behavior is opposite to the second driving behavior, the first state information comprises a flag indicating whether the first control instruction and the second control instruction exist, and determining whether an abnormality occurs in the remote driving system based on the first state information comprises: determining that an operation of the third control device or the fourth control device is abnormal in response to the simultaneous presence of the first control instruction and the second control instruction. In the case that the control instructions of two control devices that control opposite behaviors present at the same time, it is indicated that at least one of the two control devices is abnormal. For example, the third control device is the brake of the remote driving system, and the fourth control device is the accelerator of the remote driving system. If the acceleration instruction corresponding to the accelerator and the brake instruction corresponding to the brake exist at the same time (that is, the acceleration value in the acceleration instruction and the deceleration value in the brake instruction are both not 0), it is indicated that the accelerator and the brake may be pressed at the same time, which is an abnormal operation.

According to some embodiments, the remote driving system comprises a data collection device for collecting an environment information of an environment where the remote driving system is located, the first state information comprises a first data collected by the data collection device, and determining whether an abnormality occurs in the remote driving system based on the first state information comprises: determining that the data collection device is abnormal in response to the first data not satisfying a preset condition. The data collection device includes an image collection device (e.g., a visual camera, etc.), an infrared camera, a temperature sensor, a humidity sensor, and the like. Based on the first data of the data collection device, whether the environment where the data collection device and/or the remote driving system is located is abnormal can be quickly determined, and the efficiency of the abnormality detection of the remote driving system is improved to ensure the safety of remote driving.

According to some embodiments, in the case that the data collection device is an image collection device, the first data includes an image, and determining that the data collection device is abnormal in response to the first data not satisfying the preset condition comprises: performing target detection on the image to determine position coordinates of the first control device for controlling the vehicle in the image; and determining that a shooting angle of the image collection device is abnormal in response to the position coordinates being not within a preset coordinate range. According to the position coordinates of the image collection of the remote driving system, whether the shooting angle of the image collection device is abnormal is quickly determined, and the efficiency of the abnormality detection of the remote driving system is improved to ensure the safety of remote driving.

According to some embodiments, the remote driving system comprises a control host and a hardware device connected to a port of the control host, the first state information comprises a port information of the port to which the hardware device is connected, and determining whether the remote driving system is abnormal based on the first state information comprises: determining that the connection of the hardware device is abnormal in response to the port information indicating that the port is not occupied. By detecting the occupancy of the port to which the hardware device is connected, whether the connection between the hardware device and the control host is abnormal can be quickly determined.

According to some embodiments, the first state information includes state information of the control host, for example, the disk occupancy rate, the central processing unit (CPU) occupancy rate, the memory occupancy rate, and the like. The disk occupancy rate, the CPU occupancy rate and/or the memory occupancy rate may be detected according to a detection cycle. In the case that the disk occupancy rate, the CPU occupancy rate, or the memory occupancy rate is greater than a threshold, it is determined that the remote driving system is abnormal.

According to some embodiments, the first state information includes a state information of a remote control process. The state information of the remote control process is used to indicate whether the remote driving system is remotely controlling the corresponding vehicle at the moment. The remote control process may be detected according to a detection cycle. In the case that the remote control process is not detected, it is determined that an abnormality occurs in the remote driving system.

According to some embodiments, the first state information includes network state information. The network state information may be detected by PING (Packet Internet Grouper, Internet Packet Explorer) instruction, and network latency and packet loss information can be obtained. Whether the network connection of the remote driving system is abnormal may be determined through the network state information.

In step S230, determining abnormality information of the remote driving system in response to the occurrence of the abnormality in the remote driving system.

According to some embodiments, the abnormality information may include an abnormality number, an abnormality category, an abnormality description text, an abnormality alarm level, and an abnormality handling action. The category of an abnormality includes the specific location where the abnormality occurs, such as the hardware, the software, the system, the interactive device, and/or the network transmission of the remote driving system, and the like. The alarm level and the handling action of the abnormality may be obtained by looking up a table, for example, the corresponding alarm level and handling action may be obtained from a configuration file based on the abnormality number and the abnormality category.

In step S240, adjusting a state of the remote control for the vehicle communicatively connected with the remote driving system based on the abnormality information.

According to some embodiments, the abnormality information includes an abnormality handling action. Adjusting the state of the remote control based on the abnormality information comprises: suspending the remote control; handling the abnormality according to the handling action; and resuming the remote control in response to the abnormality being eliminated. After determining that the remote driving system is abnormal, the remote control of the remote driving system for the connected vehicle should be suspended first, and then the remote control for the vehicle may be resumed after the abnormality is handled according to the handling action in the abnormality information, so as to ensure the safety of remote driving.

According to some embodiments, the abnormality information further includes an alarm level of the abnormality, and suspending the remote control comprises: suspending the remote control in response to the alarm level being higher than a second threshold. The alarm level may include a fatal level (Fatal), an important level (Important), a warning level (Warning), and the like. In the case that the alarm level is a fatal level and an important level, the remote control should be automatically suspended to ensure the safety of remote driving. In the case that the alarm level is a warning level, the remote control may not be suspended to prevent frequent interruption of the remote control by alarms that do not affect the safety of remote driving. The alarm level and the specific handling actions for different alarm levels may be set according to actual needs, which is not limited herein.

FIG. 3 illustrates a schematic diagram of a remote driving system according to some embodiments of the remote driving method 200. As shown in FIG. 3, the remote driving system 300 includes an abnormality detection module 310 and a control module 320. The abnormality detection module 310 can communicate (e.g., communicate via a WebSocket) with the control module 320, and the abnormality detection module 310 can receive a state message (e.g., a first state message) sent by the control module 320 and can send an abnormality detection result to the control module 320. The control module 320 can send a control instruction (e.g., to suspend the remote control and/or resume the remote control) to the vehicle communicatively connected with the remote driving system 300 based on the abnormality detection result sent by the abnormality detection module 310. The abnormality detection module 310 includes a human-computer interactive layer detection unit 311, a network transmission layer detection unit 312, a software layer detection unit 313, a hardware layer detection unit 314, and a system layer detection unit 315. The control module 320 includes an interactive device 321, a network 322, a control software 323, a control hardware 324, and an operating system 325. The human-computer interactive layer detection unit 311 can perform abnormality detection on the interactive device 321 according to the remote driving method 200, the network transmission layer detection unit 312 can perform abnormality detection on the network 322 according to the remote driving method 200, the software layer detection unit 313 can perform abnormality detection on the control software 323 according to the remote driving method 200, the hardware layer detection unit 314 can perform abnormality detection on the control hardware 324 according to the remote driving method 200, and the system layer detection unit 315 can perform abnormality detection on the operating system 325 according to the remote driving method 200.

The abnormality information of the remote driving system 300 may include, for each abnormality item, an abnormality number, an abnormality category, an abnormality description text, an alarm level, and an abnormality handling action, as shown in the following table.

| Abnormality | Abnormality | | | Abnormality Handling |
|---|---|---|---|---|
| No. | Category | Abnormality Description Text | Alarm level | Action |
| 1-001 | System Level | Disk >80% | Fatal | Please check the disk |
| | | | | occupancy |
| 1-002 | System Level | Mem >80% | Fatal | Please check the |
| | | | | memory occupancy |
| 1-003 | System Level | CPU >80% | Fatal | Please check the CPU |
| | | | | occupancy |
| 1-004 | System Level | Disk >70% | Warning | Please check the disk |
| | | | | occupancy |
| 2-001 | Hardware Layer | Steering wheel, brake, accelerator | Fatal | Please unplug and plug |
| | | unconnected | | the steering wheel |
| 2-002 | Hardware Layer | Display being incorrectly | Fatal | Please check the display |
| | | connected | | |
| 2-003 | Hardware Layer | Scram button failure | Fatal | Please check the scram |
| | | | | button |
| 2-004 | Hardware Layer | Cockpit camera unconnected | Fatal | Please check the camera |
| 2-005 | Hardware Layer | Incorrect cockpit camera shooting | Fatal | Please check the camera |
| | | angle | | |
| 3-001 | Software Layer | Vehicle control related processes | Fatal | Please restart the |
| | | do not exist | | software |
| 3-002 | Software Layer | the status of vehicle, cockpit and | Fatal | Contact technicians |
| | | cloud being out of | | |
| | | synchronization | | |
| 3-003 | Software Layer | Cabin gears being out of | Fatal | Please check the |
| | | synchronization | | vehicle-side network |
| 3-004 | Software Layer | Vehicle information missing | Fatal | Please check the |
| | | | | vehicle-side network |
| 3-005 | Software Layer | Excessive vehicle-side latency | Fatal | Please check the |
| | | | | vehicle-side network |
| 4-001 | Network | Excessive latency of the cockpit | Fatal | Please check the cockpit |
| | Transmission | network | | side network. |
| | Layer | | | |
| 4-002 | Network | Excessive packet loss of the | Fatal | Please check the cockpit |
| | Transmission | cockpit network | | side network. |
| | Layer | | | |
| 4-003 | Network | Communication link being | Fatal | Please check the cockpit |
| | Transmission | disconnected | | side network. |
| | Layer | | | |
| 5-001 | Human-Computer | Brake and accelerator being | Fatal | Please operate correctly |
| | Interactive (HCI) | pressed at the same time | | |
| | Layer | | | |
| 5-002 | Human-Computer | Steering wheel being out of | Fatal | Please synchronize the |
| | Interactive (HCI) | synchronization | | steering wheel |
| | Layer | | | |
| 5-003 | Human-Computer | Vehicle control software window | Fatal | Please click the window |
| | Interactive (HCI) | missing | | |
| | Layer | | | |

According to embodiments of the present disclosure, the method 200 further comprises performing statistical analysis on the abnormality information of the remote driving system, providing a remote driving system indicator statistical analysis function, and reporting the analyzed indicator information to a visualization platform.

According to some embodiments, the remote driving system indicator statistical analysis includes a function of counting the time of each abnormality item. The function can automatically count the time of each abnormality item in a certain period (e.g., every day, weekly, etc.), then categorize, summarize, and upload the abnormality items to a cloud visualization platform (for example, the server 130 shown in FIG. 1 or other cloud servers not shown in FIG. 1) according to the abnormality time and the abnormality category, so as to facilitate further follow-up of the abnormal problem and improve the efficiency of abnormality handling of the remote driving system.

According to some embodiments, the remote driving system indicator statistical analysis includes performing statistical analysis on the indicator “remote driving system availability”. The “remote driving system availability ” indicator is used to count the proportion of the remote driving system in the normal operating state in the operating state of the remote driving system. The “remote driving system availability” indicator is very important in the representation of the control state and control capability of the remote driving system on a vehicle. When the “remote driving system availability” indicator is low, it is indicated that that the remote driving system has poor control on the vehicle. The “remote driving system availability” indicator may be calculated by the following equation:

$$\\ \begin{matrix}Remote driving system availability = \frac{Total abnormal time of the remote driving system}{\begin{matrix}The total operating time after \\ the remote driving system is started\end{matrix}} & ( 1 )\end{matrix}$$

where the total abnormal time of the remote driving system is calculated as follows:

total abnormal time=Σ duration of abnormality item 1 ∪

Σ duration of abnormality item 2 . . . ∪ Σ duration of abnormality item n (2)

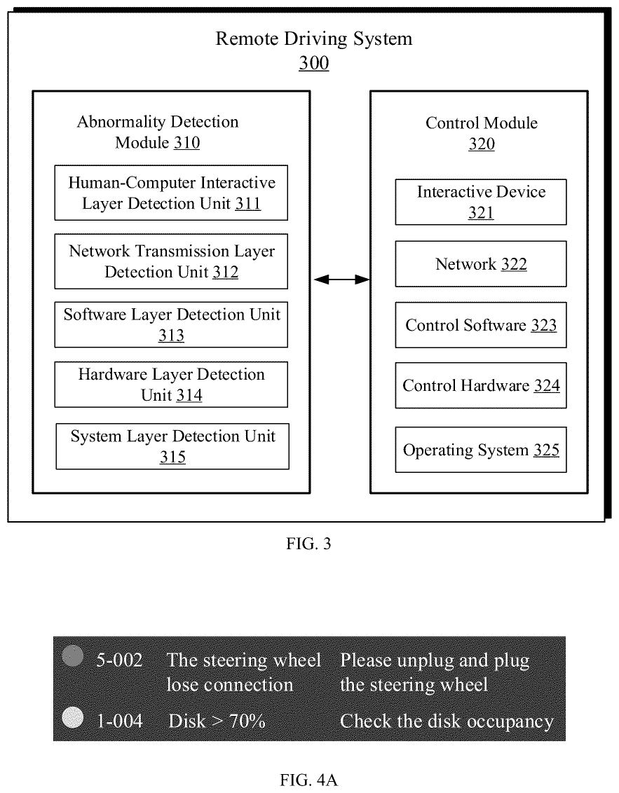

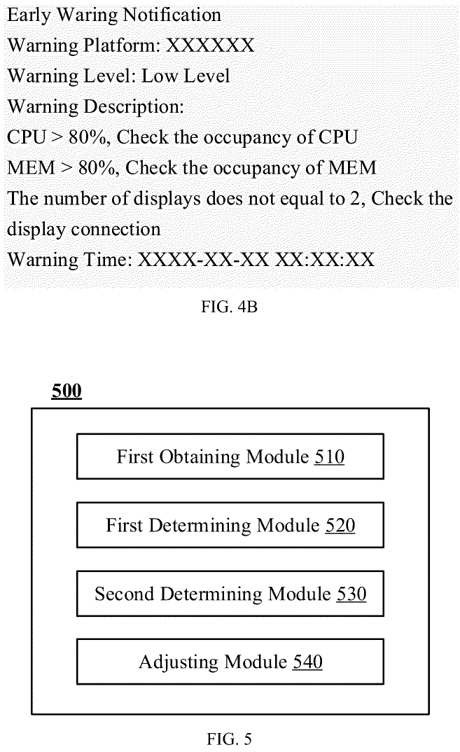

According to an embodiment of the present disclosure, the method 200 further comprises displaying the abnormality information of the remote driving system through the interaction device, that is, abnormality alarm. The abnormality alarm is divided according to the alarm level of each abnormality item, and if there are a plurality of abnormality items at the same time, priority ranking is performed according to the alarm level, and abnormality alarm with a fatal level is preferentially displayed. A schematic diagram of abnormality information display of the remote driving system is shown in FIG. 4A. The abnormality information shown in FIG. 4A is the alarm level (for example, may be a circle before the abnormality number in FIG. 4A, or may be displayed in other way), the abnormality description text ,the handling action and the like of the abnormality items 5-002 and 1-004, respectively, wherein the circle before the abnormality item 5-002 indicates that the abnormality item is a fatal level, and the circle before the abnormality item 1-004 indicates that the abnormality item is a warning level. It may be understood that the number and the specific content of the displayed abnormality information can be set according to the size of the display screen and actual needs.

According to an embodiment of the present disclosure, the method 200 further comprises sending early warning information of the remote driving system to a relevant person, for example, sending the early warning information by email, short message and/or instant messaging software. A schematic diagram of early warning information of the remote production system is shown in FIG. 4B. The abnormality information displayed in FIG. 4B includes an early warning level, an early warning description, etc., and the early warning description includes an abnormality description and a handling action of each abnormality item. It may be understood that the specific content of the early warning information may be set according to actual needs.

According to an embodiment of the present disclosure, there is provided a remote driving apparatus. FIG. 5 illustrates a structural block diagram of a remote driving apparatus 500 according to an embodiment of the present disclosure. As shown in FIG. 5, the apparatus 500 includes a first obtaining module 510, a first determining module 520, a second determining module 530, and an adjusting module 540.

The first obtaining module 510 is configured to obtain a first state information of a remote driving system. The remote driving system is configured to perform remote control on a vehicle communicatively connected with the remote driving system.

The first determining module 520 is configured to determine whether the remote driving system is abnormal based on the first state information.

The second determining module 530 is configured to determine abnormality information of the remote driving system in response to the remote driving system being abnormal.

The adjustment module 540 is configured to adjust a state of the remote control based on the abnormality information.

According to some embodiments, the remote driving apparatus 500 further comprises: a second obtaining module configured to obtain second state information of the vehicle. The first determining module 520 comprises: a synchronization determining unit configured to determine, whether the state of the remote driving system and the state of the vehicle are synchronized based on the first state information and the second state information; and an abnormality determining unit configured to determine that an abnormality occurs in the remote driving system in response to the state of the remote driving system and the state of the vehicle not being synchronized.

According to some embodiments, the remote driving system comprises a first control device, the vehicle comprises a second control device, the first control device controls the second control device to cause the vehicle to generate a corresponding driving behavior, the first state information comprises first motion information of the first control device, the second state information comprises second motion information of the second control device, and the synchronization determining unit is further configured to: determining that the second control device is not synchronized with the first control device in response to the difference between the second motion information and the first motion information being greater than a first threshold.

According to some embodiments, the remote driving system includes a third control device and a fourth control device, the third control device controls the vehicle to generate a first driving behavior through a first control instruction, the fourth control device controls the vehicle to generate a second driving behavior through a second control instruction, the first driving behavior is opposite to the second driving behavior, the first state information includes a flag indicating whether the first control instruction and the second control instruction exist, the first determining module 520 comprises: an operation determining unit configured to determine that the operation of the third control device or the fourth control device is abnormal in response to the simultaneous presence of the first control instruction and the second control instruction.

According to some embodiments, the remote driving system includes a data collection device configured to collect environmental information of an environment in which the remote driving system is located, the first state information includes first data collected by the data collection device, and the first determining module comprises: a device determining unit configured to determine that an abnormality occurs in the data collection device in response to the first data not satisfying a preset condition.

According to some embodiments, the data collection device comprises an image collection device, the first data comprises an image, and the device determining unit comprises: a position coordinate determining subunit configured to perform target detection on the image to determine the position coordinate of the first control device for controlling the vehicle in the image; and a shooting angle determining subunit configured to determine that the shooting angle of the image collection device is abnormal in response to the position coordinate being not within a preset coordinate range.

According to some embodiments, the abnormality information comprises an abnormality handling action, and the adjustment module comprises: a suspension unit configured to suspend the remote control; a processing unit configured to process the abnormality according to the handling action; and a resumption unit configured to resume the remote control in response to the abnormality being eliminated.

It should be understood that the various modules or units of the apparatus 500 shown in FIG. 5 may correspond to various steps in the method 200 described above with reference to FIG. 2. Therefore, the operations, features, and advantages described with respect to the method 200 are equally applicable to the apparatus 500 and modules and units included therein. For the sake of brevity, certain operations, features, and advantages will not be repeated here.

Although specific functions have been discussed above with reference to particular modules, it should be noted that the functions of the various units discussed herein may be divided into multiple units, and/or at least some of the multiple units may be combined into a single unit.

It should also be understood that various techniques may be described herein in the general context of software hardware elements or program modules. The various modules described above with respect to FIG. 5 may be implemented in hardware or in hardware incorporating software and/or firmware. For example, these modules may be implemented as computer program code/instructions that are configured to be executed in one or more processors and stored in a computer-readable storage medium. Alternatively, these modules may be implemented as hardware logic/circuits. For example, in some embodiments, one or more of the modules 510-540 may be implemented together in a System on Chip (SoC). The SoC may include an integrated circuit chip (which includes a processor (e.g., a Central Processing Unit (CPU), a microcontroller, a microprocessor, a Digital Signal Processor (DSP), etc.), a memory, one or more communication interfaces, and/or one or more components of other circuits), and may optionally execute the received program code and/or include an embedded firmware to perform a function.

According to embodiments of the present disclosure, there is further provided an electronic device, comprising: at least one processor; and a memory communicatively connected to the at least one processor; the memory stores instructions executable by the at least one processor, and the instructions are executed by the at least one processor, so that the at least one processor can perform a remote driving method according to an embodiment of the present disclosure.

According to embodiments of the present disclosure, there is further provided a non-transitory computer-readable storage medium storing computer instructions, and the computer instructions are used for causing the computer to execute a remote driving method according to an embodiment of the present disclosure.

According to embodiments of the present disclosure, there is further provided a computer program product, comprising a computer program, and when the computer program is executed by a processor, a remote driving method according to an embodiment of the present disclosure is implemented.

According to embodiments of the present disclosure, there is also provided a remote driving system, comprising the electrical device described above.

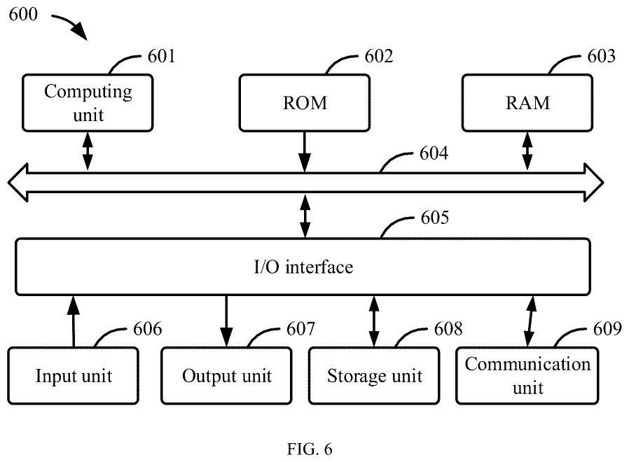

Referring to FIG. 6, a structural block diagram of an electronic device 600 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 6, the electronic device 600 includes a computing unit 601, which may perform various appropriate actions and processing according to a computer program stored in a read-only memory (ROM) 602 or a computer program loaded into a random access memory (RAM) 603 from a storage unit 608. In the RAM 603, various programs and data required by the operation of the electronic device 600 may also be stored. The computing unit 601, the ROM 602, and the RAM 603 are connected to each other through a bus 604. Input/output (I/O) interface 605 is also connected to the bus 604.

A plurality of components in the electronic device 600 are connected to a I/O interface 605, including: an input unit 606, an output unit 607, a storage unit 608, and a communication unit 609. The input unit 606 may be any type of device capable of inputting information to the electronic device 600, the input unit 606 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 607 may be any type of device capable of presenting information, and may include, but are not limited to, a display, a speaker, a video/audio output terminal, a vibrator, and/or a printer. The storage unit 608 may include, but is not limited to, a magnetic disk and an optical disk. The communication unit 609 allows the electronic device 600 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 601 may be a variety of general and/or special purpose processing components with processing and computing capabilities. Some examples of the computing unit 601 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 601 performs the various methods and processes described above, such as method 200. For example, in some embodiments, the method 200 may be implemented as a computer software program tangibly contained in a machine-readable medium, such as the storage unit 608. In some embodiments, part or all of the computer program may be loaded and/or installed onto the electronic device 600 via the ROM 602 and/or the communication unit 609. When the computer program is loaded to the RAM 603 and executed by the computing unit 601, one or more steps of the method 200 described above may be performed. Alternatively, in other embodiments, the computing unit 601 may be configured to perform the method 200 by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component(e.g., as a data server), or a computing system including a middleware component (e.g., an application server), or a computing system including a front-end component (e.g., a user computer with a graphical user interface or a web browser, the user may interact with implementations of the systems and techniques described herein through the graphical user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely example embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of the technology, many elements described herein may be replaced by equivalent elements appearing after the present disclosure.

What is claimed is:

1. A method, comprising:
obtaining a first state information of a remote driving system, wherein the remote driving system is configured to perform remote control on a vehicle communicatively connected with the remote driving system;
determining whether an abnormality occurs in the remote driving system based on the first state information;
determining abnormality information of the remote driving system in response to the occurrence of the abnormality in the remote driving system; and
adjusting a state of the remote control based on the abnormality information.

2. The method according to claim 1, further comprising:
obtaining a second state information of the vehicle,
wherein the determining whether an abnormality occurs in the remote driving system comprises:
determining whether a state of the remote driving system and a state of the vehicle are synchronized based on the first state information and the second state information; and
determining that an abnormality occurs in the remote driving system in response to the state of the remote driving system being out of synchronization with the state of the vehicle.

3. The method according to claim 2, wherein the remote driving system comprises a first control device, and the vehicle comprises a second control device, the first control device configured to control the second control device to cause the vehicle to generate a corresponding driving behavior, wherein the first state information comprises a first motion information of the first control device, and the second state information comprises a second motion information of the second control device, and wherein the determining whether the state of the remote driving system and the state of the vehicle are synchronized comprises:
determining that the second control device is not synchronized with the first control device in response to a difference between the second motion information and the first motion information being greater than a first threshold.

4. The method according to claim 1, wherein the remote driving system comprises a third control device and a fourth control device, the third control device configured to control the vehicle to generate a first driving behavior through a first control instruction, and the fourth control device configured to control the vehicle to generate a second driving behavior through a second control instruction, wherein the first driving behavior is opposite to the second driving behavior, and the first state information comprises a flag indicating whether the first control instruction and the second control instruction present, and wherein the determining whether an abnormality occurs in the remote driving system comprises:
determining that an operation of the third control device or the fourth control device is abnormal in response to the simultaneous presence of the first control instruction and the second control instruction.

5. The method according to claim 1, wherein the remote driving system comprises a data collection device for collecting an environmental information of an environment in which the remote driving system is located, and the first state information comprises a first data collected by the data collection device, and wherein the determining whether an abnormality occurs in the remote driving system comprises:
determining that an abnormality occurs in the data collection device in response to the first data not satisfying a preset condition.

6. The method according to claim 5, wherein the data collection device comprises an image collection device, and the first data comprises an image, and wherein the determining that an abnormality occurs in the data collection device comprises:
performing target detection on the image to determine position coordinates of a first control device for controlling the vehicle in the image; and
determining that a shooting angle of the image collection device is abnormal in response to the position coordinates being not within a preset coordinate range.

7. The method according to claim 1, wherein the remote driving system comprises a control host and a hardware device connected to a port of the control host, the first state information comprising a port information of the port, and wherein the determining whether an abnormality occurs in the remote driving system comprises:
determining that a connection of the hardware device is abnormal in response to the port information indicating that the port is not occupied.

8. The method according to claim 1, wherein the abnormality information comprises a handling action for the abnormality, and wherein the adjusting the state of the remote control comprises:
suspending the remote control;
handling the abnormality according to the handling action; and
resuming the remote control in response to the abnormality being eliminated.

9. The method according to claim 8, wherein the abnormality information further comprises an alarm level of the abnormality, and wherein the suspending the remote control comprises:
suspending the remote control in response to the alarm level being greater than a second threshold.

10. An electronic device, comprising:
a processor; and
a memory communicatively connected with the processor; wherein
the memory stores instructions executable by the processor, wherein the instructions, when executed by the processor, are configured to cause the processor to perform operations comprising:
obtaining a first state information of a remote driving system, wherein the remote driving system is configured to perform remote control on a vehicle communicatively connected with the remote driving system;
determining whether an abnormality occurs in the remote driving system based on the first state information;
determining abnormality information of the remote driving system in response to the occurrence of the abnormality in the remote driving system; and
adjusting a state of the remote control based on the abnormality information.

11. The electronic device according to claim 10, wherein the operations further comprise:
obtaining a second state information of the vehicle,
wherein the determining whether an abnormality occurs in the remote driving system comprises:
determining whether a state of the remote driving system and a state of the vehicle are synchronized based on the first state information and the second state information; and
determining that an abnormality occurs in the remote driving system in response to the state of the remote driving system being out of synchronization with the state of the vehicle.

12. The electronic device according to claim 11, wherein the remote driving system comprises a first control device, and the vehicle comprises a second control device, the first control device configured to control the second control device to cause the vehicle to generate a corresponding driving behavior, wherein the first state information comprises a first motion information of the first control device, and the second state information comprises a second motion information of the second control device, and wherein the determining whether the state of the remote driving system and the state of the vehicle are synchronized comprises:
determining that the second control device is not synchronized with the first control device in response to a difference between the second motion information and the first motion information being greater than a first threshold.

13. The electronic device according to claim 10, wherein the remote driving system comprises a third control device and a fourth control device, the third control device configured to control the vehicle to generate a first driving behavior through a first control instruction, and the fourth control device configured to control the vehicle to generate a second driving behavior through a second control instruction, wherein the first driving behavior is opposite to the second driving behavior, and the first state information comprises a flag indicating whether the first control instruction and the second control instruction present, and wherein the determining whether an abnormality occurs in the remote driving system comprises:
determining that an operation of the third control device or the fourth control device is abnormal in response to the simultaneous presence of the first control instruction and the second control instruction.

14. The electronic device according to claim 10, wherein the remote driving system comprises a data collection device for collecting an environmental information of an environment in which the remote driving system is located, and the first state information comprises a first data collected by the data collection device, and wherein the determining whether an abnormality occurs in the remote driving system comprises:
determining that an abnormality occurs in the data collection device in response to the first data not satisfying a preset condition.

15. The electronic device according to claim 14, wherein the data collection device comprises an image collection device, and the first data comprises an image, and wherein the determining that an abnormality occurs in the data collection device comprises:
performing target detection on the image to determine position coordinates of a first control device for controlling the vehicle in the image; and
determining that a shooting angle of the image collection device is abnormal in response to the position coordinates being not within a preset coordinate range.

16. The electronic device according to claim 10, wherein the remote driving system comprises a control host and a hardware device connected to a port of the control host, the first state information comprising a port information of the port, and wherein the determining whether an abnormality occurs in the remote driving system comprises:
determining that a connection of the hardware device is abnormal in response to the port information indicating that the port is not occupied.

17. The electronic device according to claim 10, wherein the abnormality information comprises a handling action for the abnormality, and wherein the adjusting the state of the remote control comprises:
suspending the remote control;
handling the abnormality according to the handling action; and
resuming the remote control in response to the abnormality being eliminated.

18. The electronic device according to claim 17, wherein the abnormality information further comprises an alarm level of the abnormality, and wherein the suspending the remote control comprises:
suspending the remote control in response to the alarm level being greater than a second threshold.

19. A non-transitory computer-readable storage medium storing computer instructions, wherein the computer instructions are configured to enable a computer to perform operations comprising:
obtaining a first state information of a remote driving system, wherein the remote driving system is configured to perform remote control on a vehicle communicatively connected with the remote driving system;
determining whether an abnormality occurs in the remote driving system based on the first state information;
determining abnormality information of the remote driving system in response to the occurrence of the abnormality in the remote driving system; and
adjusting a state of the remote control based on the abnormality information..

20. The non-transitory computer-readable storage medium according to claim 19, wherein the abnormality information comprises a handling action for the abnormality, and wherein the adjusting the state of the remote control comprises:
suspending the remote control;
handling the abnormality according to the handling action; and
resuming the remote control in response to the abnormality being eliminated.
